(19) United States
(12) Patent Application Publication
(10) Pub. No.: US 2010/0300826 A1
(43) Pub. Date: Dec. 2, 2010

(54) NON-CONDUCTIVE TRAILING CABLE GUIDE

(75) Inventors: Adam S. Peterson, Franklin, PA (US); Michael A. Fair, Cranberry, PA (US)

Correspondence Address: JAMES EARL LOWE, JR., 15417 W NATIONAL AVE # 300, NEW BERLIN, WI, 53151, US

(73) Assignee: Joy MM Delaware, Wilmington, DE (US)

(21) Appl. No.: 12/475,455

(22) Filed: May 29, 2009

(51) Int. Cl. H02G 11/02; B65H 57/14; B65H 75/42

(52) U.S. Cl. 191/12.2 R; 242/397.5

(57) ABSTRACT

An electric vehicle powered by a trailing cable, the vehicle including a cable guide for guiding cable onto a reel as the cable is paid out and taken up. The cable guide comprises a pair of adjacent, double flanged concave rollers in alignment with each other so that their respective flanges are spaced apart by only a small distance substantially less than the cable diameter so that an essentially closed circular path is defined by the concave surfaces of the adjacent rollers so that the cable can not escape the rollers, each of the rollers including a polyurethane core that is hard and slick that creates a natural bearing surface, and an outer portion made of softer polyurethane than the core that aids in gripping and guiding the cable onto the cable reel.

### BACKGROUND

This disclosure relates to movable electric machinery having a trailing cable connected to a source of power, and, more particularly, to a cable guide for guiding the cable onto a cable reel.

Existing cable guides used today are made from conductive materials (steel) and require a series of non-conductive components to isolate the cable guide from potential frame voltages.

One example of an existing electric vehicle cable guide can be found in U.S. Hughes Pat. No. 5,385,314. This disclosure is an improvement to the cable guide found in U.S. Hughes Pat. No. 5,385,314.

### SUMMARY

It is an object of this disclosure to provide a new two-roller design offering rollers made of non-conductive material requiring no additional means to isolate the rollers from a machine frame.

Another object of this disclosure is to provide an electric vehicle with a cable guide, with the cable guide having rollers that do not require roller bearings.

This disclosure provides an electric vehicle powered by a trailing cable, the vehicle including a cable guide for guiding cable onto a reel as the cable is paid out and taken up. The cable guide comprises a pair of adjacent, double flanged concave rollers in alignment with each other so that their respective flanges are spaced apart by only a small distance substantially less than the cable diameter so that an essentially closed circular path is defined by the concave surfaces of the adjacent rollers so that the cable can not escape the rollers, each of the rollers including a polyurethane core that is hard and slick that creates a natural bearing surface, and an outer portion made of softer polyurethane than the core that aids in gripping and guiding the cable onto the cable reel.

### BRIEF DESCRIPTION OF THE DRAWINGS

FIG. 1 is a partial top view of the left rear corner of a shuttle car.

FIG. 2 is a perspective view of a cable extending through a cable guide according to this disclosure.

FIG. 3 is a cross sectional view of the cable guide shown in FIG. 2, with the cable guide mounted on a shuttle car.

FIG. 4 is a perspective view of one of the cable guide rollers in the cable guide of FIG. 2.

FIG. 5 is a side view of the guide roller shown in FIG. 4, with the hollow core of the roller shown in ghost.

Before one embodiment of the disclosure is explained in detail, it is to be understood that the disclosure is not limited in its application to the details of the construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Further, it is to be understood that such terms as “forward”, “rearward”, “left”, “right”, “upward” and “downward”, etc., are words of convenience and are not to be construed as limiting terms.

### DESCRIPTION OF THE PREFERRED EMBODIMENT

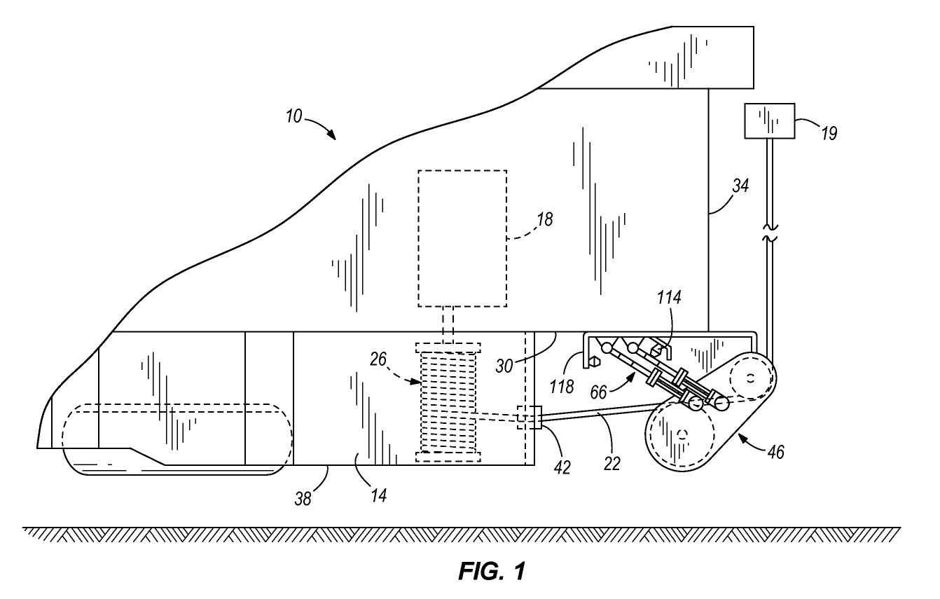

As illustrated in the drawings, this invention comprises an electric vehicle 10. More particularly, a shuttle car useful in hauling material in underground mines is shown in FIG. 1. The shuttle car 10 includes a vehicle frame 14, an electrical motor 18 on the frame 14, and a cable 22, electrically connected to the motor 18 and adapted to be connected to a source of power 19. The shuttle car 10 further includes a reel 26 on the frame 14 between the electric motor 18 and one end of the frame 14. More specifically, the reel 26 is located near the left rear 30 of the shuttle car 10 and the reel 26 provides for storage of the cable 22. Still more particularly, the cable reel is mounted on the rear portion of the vehicle frame and is rotatable on an axis.

As the shuttle car 10 moves backwards, forwards, and around corners, toward to or away from the power source, the cable 22 is either wound onto or paid out of a reel 26. The cable 22 extends from the rear 34 of the shuttle car 10, and, at times, either runs along the side 38 of the shuttle car 10, when the shuttle car 10 is moving backwards, or extends straight back from the shuttle car 10, when the shuttle car 10 is moving forward (not shown). When the shuttle car moves right around a corner, as shown in FIG. 1, the cable 22 runs along the rear 34 of the shuttle car 10. In many applications, the cable 22 can be between 500 and 750 feet long.

The shuttle car 10 further includes a cable guide 42 between the reel 26 and the rear 34 of the shuttle car 10, and a sheave bracket assembly 46 mounted on the left rear 30 of the shuttle car 10.

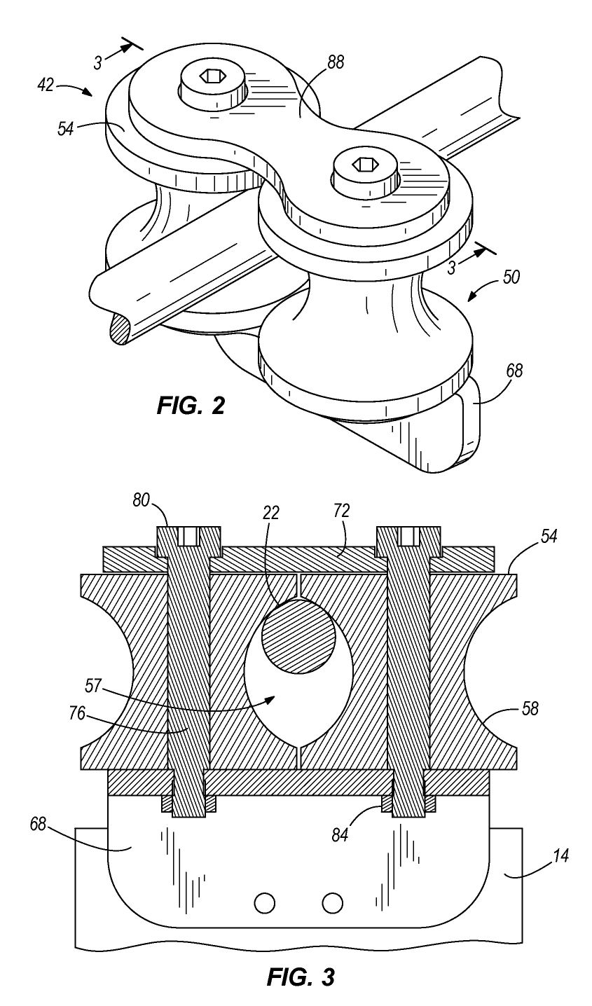

As illustrated in FIGS. 2 and 3, the cable guide 42 comprises a pair of adjacent, double flanged concave rollers 50, made of non-conductive material, in alignment with each other so that their respective flanges 54 are spaced apart by only a small distance substantially less than the cable diameter so that an essentially closed circular path 57 is defined by the concave surfaces 58 of the adjacent rollers 50, so that the cable 22 can not escape the rollers 50.

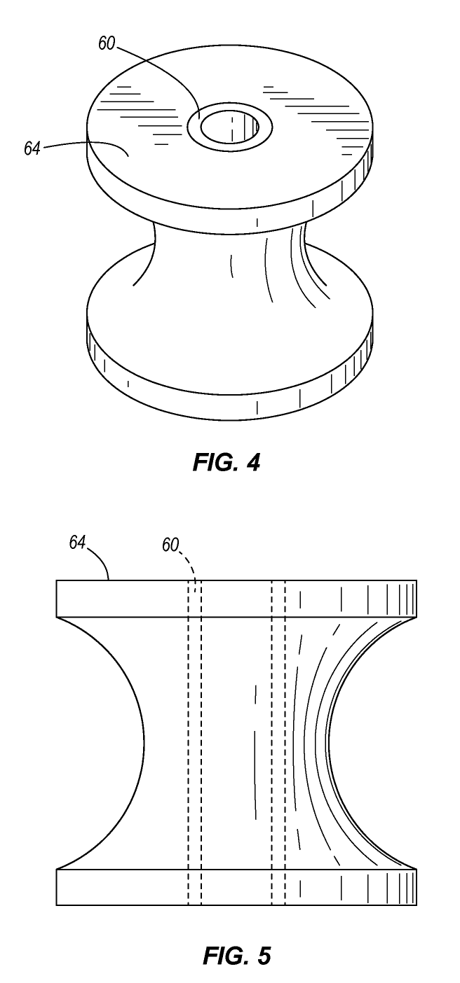

Each of the rollers 50 has no roller bearing, and includes, as shown in FIGS. 4 and 5, a polyurethane core 60 that is hard and slick to create a natural bearing surface, and an outer portion 64 made of softer polyurethane than the core 60 to aid in gripping and guiding the cable 22 onto the cable reel 26.

As illustrated in FIGS. 2 and 3, the cable guide 42 also includes a mounting bracket 68 attached to the vehicle frame 14, a support plate 72, and a pair of roller axles 76. Each roller axle 76 extends from the mounting bracket 68, through a respective roller 50 and to the support plate 72. The cable guide 42 also includes means securing the roller axle 76 to the support plate 72, in the form of a bolt head 80 on the roller axle 76, and means securing the roller axle 76 to the mounting bracket 68, in the form of a nut 84 on the threaded end of the roller axle 76. Each roller axle 76 passes through aligned openings in the mounting bracket 68 and support plate 72.

The support plate 72 is figure eight shaped, with the round portions 88 of the figure eight being positioned above the rollers 50. The diameter of the round portions 88 is smaller than the diameter of the top flanges 54 of the rollers 50.

1. An electric vehicle powered by a trailing cable having a diameter and adapted to be connected to a power source, said vehicle comprising:
a vehicle frame,
a cable reel mounted on a rear portion of said vehicle frame and rotatable on an axis so that said reel turns to take up and pay out the cable as the vehicle moves toward and away from a power source, and
a cable guide for guiding cable onto the reel as the cable is paid out and taken up, said cable guide comprising
a pair of adjacent, double flanged concave rollers, made of non-conductive material, in alignment with each other so that their respective flanges are spaced apart by only a small distance substantially less than the cable diameter so that an essentially closed circular path is defined by the concave surfaces of the adjacent rollers so that the cable can not escape the rollers,
a mounting bracket attached to said vehicle frame,
a support plate,
a pair of roller axles, each roller axle extending from said mounting bracket, through a respective roller and to said support plate,
means securing said roller axle to said support plate, and
means securing said roller axle to said mounting bracket.

2. An electric vehicle according to claim 1 wherein said support plate is figure eight shaped, with the round portions of the figure eight being positioned above the rollers and being smaller than the top flanges of the rollers.

3. An electric vehicle powered by a trailing cable having a diameter and adapted to be connected to a power source, said vehicle comprising:
a vehicle frame,
a cable reel mounted on a rear portion of said vehicle frame and rotatable on an axis so that said reel turns to take up and pay out the cable as the vehicle moves toward and away from a power source, and
a cable guide for guiding cable onto the reel as the cable is paid out and taken up, said cable guide comprising
a pair of adjacent, double flanged concave rollers in alignment with each other so that their respective flanges are spaced apart by only a small distance substantially less than the cable diameter so that an essentially closed circular path is defined by the concave surfaces of the adjacent rollers so that the cable can not escape the rollers, each of said rollers including
a polyurethane core that is hard and slick that creates a natural bearing surface, and
an outer portion made of softer polyurethane than said core that aids in gripping and guiding the cable onto said cable reel,
a mounting bracket attached to said vehicle frame,
a support plate,
a pair of roller axles, each roller axle extending from said mounting bracket, through a respective roller and to said support plate,
means securing said roller axle to said support plate, and
means securing said roller axle to said mounting bracket.

4. An electric vehicle according to claim 3 wherein said support plate is figure eight shaped, with the round portions of the figure eight being positioned above the rollers and being smaller than the top flanges of the rollers.
